(19) United States
(12) Patent Application Publication
(10) Pub. No.: US 2012/0100314 A1
(43) Pub. Date: Apr. 26, 2012

(54) SHEET FOR SIGNAGE THAT INCLUDES POLYETHYLENE AND OTHER MATERIALS AND METHOD OF MANUFACTURE OF THE SAME

(75) Inventor: Tseng Hsiang Lin, Kuala Lumpur (MY)

(73) Assignee: YJIP, Inc., Addison, TX (US)

(21) Appl. No.: 13/090,029

(22) Filed: Apr. 19, 2011

Related U.S. Application Data
(60) Provisional application No. 61/325,770, filed on Apr. 19, 2010.

(51) Int. Cl. B41M 5/52; B05D 3/04; B05D 5/00; B05D 1/36

(52) U.S. Cl. 428/32.2; 427/407.1; 427/569; 427/209

(57) ABSTRACT

A method of manufacturing a flexible, laminated sheet operable to receive an ink for use as signage includes mixing solidified polyethylene and at least one solidified ink binder together to form a substantially evenly distributed mixture of the same. The method also includes processing the mixture into a flowable coating layer having a substantially even distribution of the polyethylene and the at least one ink binder. Moreover, the method includes coating the coating layer onto a substrate.

### CROSS-REFERENCE TO RELATED APPLICATIONS

This application claims the benefit of U.S. Provisional Application No. 61/325,770, filed on Apr. 19, 2010. The entire disclosure of the above application is incorporated herein by reference.

### FIELD

The present disclosure relates to a sheet for signage and, more particularly, relates to a sheet for signage that includes polyethylene and other materials and a method of manufacturing the same.

### BACKGROUND

This section provides background information related to the present disclosure which is not necessarily prior art.

Many goods include relatively large sheets of flexible material with inks applied thereto. For instance, billboards and banners are often used for advertising, for decorations, etc. Also, other goods, such as tents, gazebos, and temporary shelters include a flexible sheet that is supported above the ground by a rigid frame, and logos, pictures, and other objects can be printed on these sheets of materials.

Typically, these printed sheets are manufactured by laminating a substrate sheet with multiple layers in several laminating steps. For instance, a single material can be laminated on the substrate, followed by another layer of another material, and so on until the sheet is completed. Then, the fully laminated sheet can be printed with the desired logos, objects, etc.

Although these sheets and manufacturing processes have been adequate for their intended purposes, certain disadvantages remain. For instance, because there are separate laminating steps, the manufacturing process can be inefficient. More specifically, manufacturing time can be significant because of the separate laminating steps. Also, manufacturing in this manner can use up significant electricity for powering the separate laminating steps.

Moreover, use of one or more of the components can have a substantial negative environmental impact. For instance, one of the materials to be laminated on the substrate may be in a liquid form and may solidify during the manufacturing process. Once solidified, it may be impossible to re-melt and/or recycle the material. As such, there can be significant waste produced using these methods.

### SUMMARY

This section provides a general summary of the disclosure, and is not a comprehensive disclosure of its full scope or all of its features.

A method of manufacturing a flexible, laminated sheet operable to receive an ink for use as signage is disclosed. The method includes mixing solidified polyethylene and at least one solidified ink binder together to form a substantially evenly distributed mixture of the same. The method also includes processing the mixture into a flowable coating layer having a substantially even distribution of the polyethylene and the at least one ink binder. Moreover, the method includes coating the coating layer onto a substrate.

A flexible, laminated sheet operable to receive an ink for use as signage is also disclosed. The sheet includes a substrate and a coating layer that is layered on the substrate. The coating layer has a substantially even distribution of a polyethylene and at least one ink binder throughout. The coating layer provides a surface to which the ink can be received.

A method of manufacturing a flexible, laminated sheet operable to receive an ink for use as signage is further disclosed. The method includes mixing pelletized low density polyethylene (LDPE), at least one pelletized ink binder, and a pelletized whitener together to form a substantially evenly distributed mixture of the same. The at least one pelletized ink binder is chosen from a group consisting of ethylene vinyl acetate (EVA), polyvinyl acetate (PVA), and ethylene methyl methacrylate copolymer (EMMA). The at least one pelletized ink binder makes up between approximately 5% and 25% of the at least one mixture. Also, the method includes extruding the mixture into a flowable coating layer having a substantially even distribution of the polyethylene and the at least one ink binder. Still further, the method includes coating the coating layer onto a substrate made from woven strips of high density polyethylene (HDPE). Additionally, the method includes treating a surface of the coating layer to at least one of coronal discharge and plasma treatment.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flowchart of a method of manufacturing a sheet suitable for use as signage according to various exemplary embodiments of the present disclosure; and

FIG. 2 is a schematic illustration of a cross section of the sheet manufactured using the method of FIG. 1.

Corresponding reference numerals indicate corresponding parts throughout the several views of the drawings.

### DETAILED DESCRIPTION

Example embodiments will now be described more fully with reference to the accompanying drawings.

Referring initially to FIG. 2, a schematic illustration of a flexible, laminated sheet 40 is shown. The sheet 40 is shown in cross section and includes a plurality of laminated layers 50, 60a, 60b, each of which will be described. Also, the sheet 40 can be suitable for receiving an ink 70. The ink 70 can be printed or otherwise applied to the sheet 40. Thus, as will be discussed, the sheet 40 can be used as signage, for instance, as a billboard, as a banner, as a printed sheet included on a gazebo, temporary shelter, etc. Furthermore, as will be discussed, the sheet 40 can be manufactured in an efficient manner. Moreover, the sheet 40 can be manufactured in a way that reduces negative environmental impact.

As shown, the laminated sheet 40 includes a substrate 50, a first coating layer 60a, and a second coating layer 60b. The first coating layer 60a is laminated and layered on a first side 56 (top side) of the substrate 50, and the second coating layer 60b is laminated and layered on a second side 58 (bottom side) of the substrate 50. The first and second sides 56, 58 are opposite each other. The ink 70 can be applied (e.g., by printing) to an outer surface 62 of the first coating layer 60a, as shown. In additional embodiments, the ink 70 can be applied to the second coating layer 60b. Moreover, in some embodiments, the sheet 40 can include only one of the coating layers 60a, 60b.

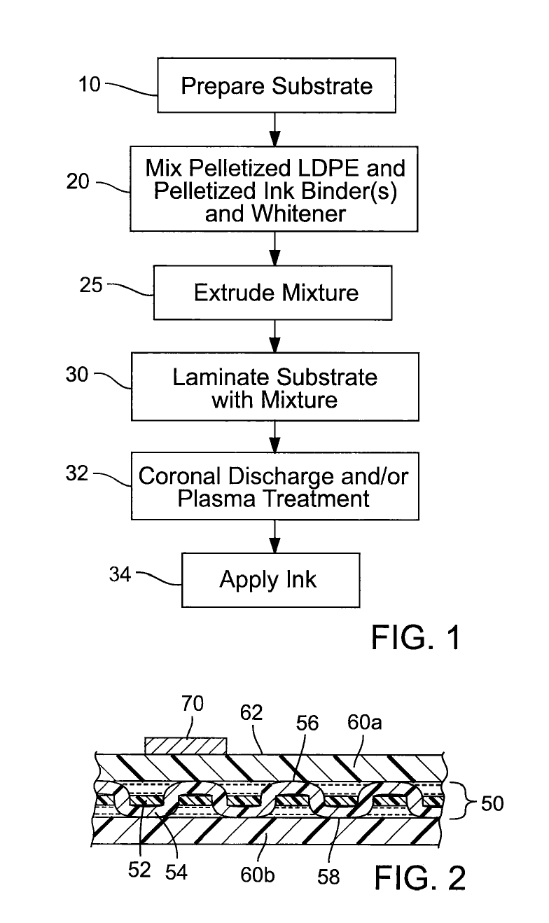

Referring now to FIG. 1, a method of manufacturing the sheet 40 is shown. Beginning in block 10, the substrate 50 is prepared. The substrate 50 can be formed from solidified HDPE (e.g., HDPE pellets or beads). This solidified HDPE can be processed to become liquid resin or otherwise flowable, for instance, in a known extrusion process. The HDPE can be extruded into a thin, flat sheet, and the sheet can be cut into a plurality of thin, flat, elongate strips 52, 54 (FIG. 2) or tapes. These strips 52, 54 can then be woven together to form the substrate 50 into a woven sheet. Specifically, the substrate 50 can be woven in a known manner to include weft strips 52 and warp strips 54 that extend across the length and width of the substrate 50.

The substrate 50 can have any suitable dimensions. For instance, the substrate 50 can have a width of up to six feet. Also, the strips 52, 54 can have any suitable color, such as black or white. Moreover, preparation of the substrate 50 can include stretching of the HDPE material, either before or after being cut into the strips 52, 54.

It will be appreciated that the HDPE material of the substrate 50 can have a relatively low environmental impact because HDPE can be recycled, for instance. However, it will be appreciated that the substrate 50 could be made from any suitable material.

Referring back to FIG. 1, the method can continue in block 20, in which the material used for the coating layers 60a, 60b is prepared. Specifically, polyethylene (e.g., low density polyethylene or LDPE), one or more ink binders, and a pigment (e.g., a white pigment or whitener) are mixed.

The ink binder(s) included in block 20 can be ethylene vinyl acetate (EVA), polyvinyl acetate (PVA), and ethylene methyl methacrylate copolymer (EMMA). These are known materials that allow the ink 70 (FIG. 2) to bind or otherwise join to the coating layer 60a. Only one of these ink binders, a combination of these ink binders, or any other ink binders can be used. Also, the ink binder(s) can make up any suitable percentage of the coating layers 60a, 60b. For instance, in some embodiments, the ink binder(s) can make up between approximately 5% and 25% of each coating layer 60a, 60b.

The pigment (e.g., whitener) used in block 20 can be of any suitable type for affecting the color of the coating layers 60a, 60b. For instance, the pigment can be titanium dioxide (Ti0₂) that makes the coating layers 60a, 60b substantially white. Also, block 20 can include adding a UV-resisting material, such as 2-Hydroxy-4-n-octoxy-benzophenone (C₂₁H₂₆O₃) to the mixture such that the sheet 40 will be resistant to degradation due to ultraviolet ray exposure.

In block 20, one or more of the ingredients can be in a solid state before and during mixture. Specifically, the LDPE, ink binder(s), whitener, and UV-resisting material can each be supplied in solid pellets or beads (i.e., pelletized). Then, these ingredients can be mixed together (e.g., by a drum mixer or other agitator) such that the ingredients become substantially uniformly mixed and evenly distributed.

Next, in block 25, the materials previously mixed in block 20 are processed until the mixture is melted and flowable. Specifically, the mixture can be extruded into a flowable resin. The materials can remain substantially uniformly mixed and evenly distributed throughout this flowable resin.

Subsequently, in block 30, the coating layers 60a, 60b can be laminated on the substrate 50. Specifically, the substrate 50 can be fed relative to an extrusion head while the mixture of the coating layer 60a flows onto and coats the surface 56 of the substrate 50. The coating layer 60a can then be cured into a substantially continuous layer covering the substrate 50, and the substantially even distribution of the LDPE, ink binder(s) and other ingredients can remain within the coating layer 60a. The coating layer 60b can be applied in a similar fashion to the other surface 58 of the substrate 50.

It will be appreciated that the coating layers 60a, 60b can be laminated to the substrate 50 in any suitable fashion. For instance, the coating layers 60a, 60b can be sprayed or jetted onto the substrate 50. Also, heat and/or pressure can also be applied to the sheet 40 in order to adhere and laminate the coating layers 60a, 60b to the substrate 50. In other embodiments, the substrate 50 and coating layers 60a, 60b can be laminated together using additional adhesives.

Next, in block 32, the sheet 40 can be subjected to coronal discharge, plasma treatment, and/or other procedures for increasing the wettability of the sheet 40. For instance, the surface 62 of the coating layer 60a can be subjected to one or more of these processes. As such, the ink can more readily bind, adhere, or otherwise join to the surface 62 of the sheet 40.

The sheet 40 can also be subjected to testing and other procedures. For instance, the sheet 40 can be dyne level tested, strength tested, etc.

Finally, in block 34, the ink 70 can be applied to the surface 62 of the sheet 40. The ink 70 can be of any suitable type, such as solvent, water-based, or UV ink. The ink 70 can be printed or applied otherwise. The ink 70 can be applied in a pattern, to form a picture, words, logo, or other object. In some embodiments, the sheet 40 is manufactured in bulk and stored in rolls and shipped to a customer, and the customer cuts a desired length of the sheet 40 before applying the ink 70. Accordingly, the sheet 40 can be used to display a message or to display any other printed object as a billboard or banner. Also, the sheet 40 can be subsequently attached to a frame or other support structure to both function as a tent, canopy, or shelter as well as display a logo or other object.

Accordingly, the sheet 40 can be manufactured fairly efficiently. For instance, manufacturing time can be reduced because the ingredients of the coating layers 60a, 60b can be mixed together when in solid form, and the ingredients can be extruded together as an evenly distributed mixture. Thus, less laminating steps may be needed as compared with the prior art. Also, because the ingredients of the coating layers 60a, 60b are mixed together in solid form, these ingredients can be stable, and fairly easy to handle. Still further, obtaining an even mixture of the ingredients can readily achieved.

In addition, the sheet 40 can have relatively low environmental impact. For instance, the majority of the materials included in the sheet 40 can be polyethylene (HDPE and/or LDPE), which is highly recyclable. The addition of the ink binder(s), whitener, UV-resisting material, and/or other materials can be included in relatively low amounts, such that the materials remain highly recylable. Also, some of the material of the coating layers 60a, 60b may be left over after the sheet 40 has been formed, yet this material can be re-melted and re-used to make other sheets 40 in the future.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. For instance, it will be appreciated blocks 20 and 25 of FIG. 1 can occur before, during, or after block 10. Such variations are not to be regarded as a departure from the disclosure, and all such modifications are intended to be included within the scope of the disclosure.

What is claimed is:

1. A method of manufacturing a flexible, laminated sheet operable to receive an ink for use as signage, the method comprising:
mixing solidified polyethylene and at least one solidified ink binder together to form a substantially evenly distributed mixture of the same;
processing the mixture into a flowable coating layer having a substantially even distribution of the polyethylene and the at least one ink binder; and
coating the coating layer onto a substrate.

2. The method of claim 1, wherein mixing includes mixing pelletized polyethylene and pelletized ink binder together to form the substantially even mixture of the same.

3. The method of claim 1, wherein processing the mixture includes extruding the mixture.

4. The method of claim 1, further comprising applying an ink to a surface of the coating layer.

5. The method of claim 1, further comprising treating a surface of the coating layer to at least one of coronal discharge and plasma treatment.

6. The method of claim 1, wherein the at least one ink binder includes ethylene vinyl acetate (EVA).

7. The method of claim 1, wherein the at least one ink binder includes polyvinyl acetate (PVA).

8. The method of claim 1, wherein the at least one ink binder includes ethylene methyl methacrylate copolymer (EMMA).

9. The method of claim 1, wherein the coating layer is made up of between approximately 5% and 25% of the at least one ink binder.

10. The method of claim 1, wherein mixing further includes mixing solidified polyethylene, at least one solidified ink binder, and a solidified whitener together to form a substantially even mixture of the same.

11. The method of claim 1, wherein coating the coating layer onto the substrate includes coating the coating layer onto both a first side of the substrate and a second side of the substrate.

12. The method of claim 1, wherein the polyethylene is a low density polyethylene (LDPE).

13. The method of claim 1, wherein the substrate is made from high density polyethylene (HDPE).

14. A flexible, laminated sheet operable to receive an ink for use as signage, the sheet comprising:
a substrate; and
a coating layer that is layered on the substrate, the coating layer having a substantially even distribution of a polyethylene and at least one ink binder throughout, the coating layer providing a surface to which the ink can be received.

15. The sheet of claim 14, wherein the at least one ink binder includes ethylene vinyl acetate (EVA).

16. The sheet of claim 14, wherein the at least one ink binder includes polyvinyl acetate (PVA).

17. The sheet of claim 14, wherein the at least one ink binder includes ethylene methyl methacrylate copolymer (EMMA).

18. The sheet of claim 14, wherein the coating layer is made up of between approximately 5% and 25% of the at least one ink binder.

19. The sheet of claim 14, wherein the coating layer further includes a whitener.

20. The sheet of claim 19, wherein the whitener is Titanium Dioxide (TiO₂).

21. The sheet of claim 14, wherein the coating layer is a first coating layer that is layered on a first side of the substrate, and further comprising a second coating layer that is layered on the a second side of the substrate, the first and second sides being opposite each other, the second coating layer having a substantially even distribution of a polyethylene and at least one ink binder throughout.

22. The sheet of claim 14, wherein the polyethylene is a low density polyethylene.

23. The sheet of claim 14, wherein the substrate is made from high density polyethylene.

24. A method of manufacturing a flexible, laminated sheet operable to receive an ink for use as signage, the method comprising:
mixing pelletized low density polyethylene (LDPE), at least one pelletized ink binder, and a pelletized whitener together to form a substantially evenly distributed mixture of the same, the at least one pelletized ink binder chosen from a group consisting of ethylene vinyl acetate (EVA), polyvinyl acetate (PVA), and ethylene methyl methacrylate copolymer (EMMA), the at least one pelletized ink binder making up between approximately 5% and 25% of the at least one mixture;
extruding the mixture into a flowable coating layer having a substantially even distribution of the polyethylene and the at least one ink binder;
coating the coating layer onto a substrate made from woven strips of high density polyethylene (HDPE); and
treating a surface of the coating layer to at least one of coronal discharge and plasma treatment.
